(19) United States
(12) Patent Application Publication
(10) Pub. No.: US 2026/0286199 A1
(43) Pub. Date: Sep. 24, 2026

(54) ADDITIVES FOR IMPROVING WOOD BONDING

(71) Applicant: Evonik Operations GmbH, Essen (DE)

(72) Inventors: Kai-Oliver Feldmann, Essen (DE); Ruben Benedikt Richrath, Recklinghausen (DE); Odo Wunnicke; Diandra Katharina Nelz, Duelmen (DE)

(73) Assignee: Evonik Operations GmbH, Essen (DE)

(21) Appl. No.: 19/490,212

(22) PCT Filed: May 2, 2024
(86) PCT No.: PCT/EP2024/062019

§ 371 Date: Dec. 4, 2025

(30) Foreign Application Priority Data
Jun. 5, 2023 (EP) 23177353.2
Oct. 4, 2023 (EP) 23201507.3

(51) Int. Cl. C09J 11/08; C09J 5/00; C09J 175/08

(52) U.S. Cl. CPC C09J 11/08; C09J 5/00; C09J 175/08; C09J 2400/306

(57) ABSTRACT

NCO-containing adhesive formulations are based on isocyanate prepolymers and contain additives and these NCO-containing adhesive formulations are used in adhesive systems. A method uses the NCO-containing adhesive formulations for bonding.

### FIELD OF THE INVENTION

The invention relates to additives for isocyanate (NCO)-containing adhesive formulations, to NCO-containing adhesive formulations based on isocyanate prepolymers, to the use thereof in adhesive systems, and to a method for bonding with isocyanate (NCO)-containing adhesive formulations and the use.

### PRIOR ART

Concrete is the most important building material of our times. However, concrete production is an emissions-intensive industrial process that results in significant greenhouse gas emissions. Structural glued laminated timber construction is one solution for avoiding greenhouse gas emissions in the construction sector. Products for structural glued laminated timber construction such as OSB (oriented strand board), CLT (cross-laminated timber), GLT (glulam, glue-laminated timber) and LVL (laminated veneer lumber) consist of wood materials (for example wood lamellas, veneers, shavings, fibres, chemically-modified or infiltrated wood) and adhesives. Examples of adhesives are pMDI, PF and MF. Adhesives approved in the EU for load-bearing applications belong to the families of emulsion polymer isocyanate (EPI) adhesives (DIN EN16254 (2016)), phenoplastic and aminoplastic resins (DIN EN 301 (2018)) or polyurethane (PUR) adhesives (DIN EN 15425 (2017)) and must meet high strength requirements. It is particularly important that adequate strength is maintained even in hot conditions and when wet. A test to investigate the effect of moisture and heat on the strength of the adhesive join is the tensile shear strength test on beech wood test specimens in the wet state after boiling for 6 h, as described in DIN EN 302-1 (2017) A4. Of the adhesive types mentioned, those having isocyanate functionality are particularly noteworthy, since these do not result in formaldehyde emissions and cure at room temperature in a practicable time.

An important property of an adhesive is the wetting behaviour. Wetting is defined as the ability of liquids to form interfaces with solids. Wetting is therefore a necessary prerequisite for an adhesive bond. The wetting behaviour of non-aqueous surface coatings on wood can be improved using inter alia organic-modified siloxanes. For example, CN114806352 describes an oil for application to wood surfaces that is based on biobased glycerol acrylate esters which may comprise substrate wetting additives of the polyether-modified siloxane class. Specifically, BYK-346 is mentioned, which is described in the technical data sheet as a “silicone surfactant for water-based paints and for printing inks and overprint varnishes that greatly reduces surface tension and thus brings good improvement in substrate wetting” and contains 48% dipropylene glycol monomethyl ether.

Good wetting behaviour is known to be of critical importance also to the strength of adhesive joins in wood-based materials. However, many wetting agents known from other applications are unsuitable for adhesives having isocyanate functions (NCO), since they undergo an undesired reaction with the isocyanate functions. For example, the alcohol functions in BYK-346 react with the isocyanate groups in a typical 1K-PUR adhesive based on NCO-containing MDI/PPG prepolymers.

Almost all current standards relate to the bonding of softwoods.

The changes to climatic conditions and the threat from pests such as bark beetles mean that a transition to the processing of other lignocellulosic materials is necessary.

For this reason, hardwoods, especially beech wood, are increasingly being used in structural glued laminated timber construction.

Isocyanate-based adhesives are notable for their versatility. The high flexibility when selecting raw materials for the processing of isocyanates into polyurethane adhesives allows the very good adhesion properties of isocyanates to be paired with numerous polymer properties. Polyurethane adhesives accordingly find use either as reactive two-component or multicomponent products or as moisture-curing prepolymers, for example as a result of their easy processability, good adhesion to a variety of substrates, and toughness and flexibility of the polyurethane polymer that is ultimately cured in the adhesively bonded join.

Silicone-based surfactants have been found to be excellent surface-active substances in polyurethane formulations. They are most frequently used as foam stabilizers in insulating or flexible foams. Their property of very efficiently covering the interface between polymer and air and of reducing the surface tension and thereby stabilizing these interfaces is what makes it possible for a great many polyurethane foams to be produced in the first place. The property of reducing the surface tension of organic formulations is also exploited in the use of silicone surfactants as wetting aids. For example, adding silicone-based surfactants to paints results in better wetting of substrates with low surface energies, leading to more uniform and more defect-free coatings. For adhesive applications, for example for the structural bonding of wood using one-component moisture-curing adhesive formulations based on polyurethane prepolymers, this plays only a minor role, because of the polar surface of the wood and the way in which it is applied: forced application through compression. On the contrary, a reduction in adhesion, as is typical of silicone surfactants in polyurethane formulations, is to be expected here by those skilled in the art. Non-reactive silicone surfactants in particular, i.e. ones that do not bear isocyanate-reactive groups, remain as a separating film on any interface during the polymerization of the polyurethane and finally cured material. Silicone surfactants can accordingly be used for example as release agents in polyurethane elastomers and microcellular polyurethane foams; the adhesion of rigid polyurethane foam to metal surfaces in the production of insulation panels is reduced by silicone surfactants, and problems with adhesion in the two-layer production of polyurethane shoe soles in the presence of silicone surfactants are known to those skilled in the art.

### Object

The object was to find wetting additives for structural glued laminated timber construction that are compatible with NCO-containing adhesive formulations and result in improved strength in the adhesive join, especially after thermal stress and exposure to moisture.

### Achievement

Numerical ranges specified in the format “from x to y” also include the defined values. Where two or more preferred ranges of numbers are specified in this format, it goes without saying that all ranges resulting from combining the various endpoints are also included.

“One or more” as used herein refers to at least one and encompasses 1, 2, 3, 4, 5, 6, 7, 8, 9 or more of the types mentioned. Similarly, “at least one” means one or more, i.e. 1, 2, 3, 4, 5, 6, 7, 8, 9 or more. For example, “at least one diisocyanate” means that at least one type of molecule is used that has a diisocyanate function, but that it is also possible for two or more different types of molecules that have a diisocyanate function to be present, but not that just one or more molecules of one type of molecule having a diisocyanate function are present.

All stated percentages relating to compositions or formulations refer to the percentage by weight based on the total weight of the respective composition unless expressly stated otherwise.

“Essentially”, as used here, equates in meaning with limitation to a defined main part that may be accompanied by a smaller, likewise defined part. “The modifications essentially contain no isocyanate-reactive groups” means for example that isocyanate-reactive groups, for example groups having one or more OH functionalities, such that in a measurement of the OH value according to DIN EN ISO 4629-2 (2016) an average of less than 20 mg KOH/g, preferably less than 15 mg KOH/g, and more preferably less than 5 mg KOH/g, can be found.

The object is achieved by providing NCO-containing adhesive formulations based on isocyanate prepolymers for the bonding of lignocellulosic materials comprising additives from the group of modified siloxanes, characterized in that the modifications essentially contain no isocyanate-reactive groups and that the prepolymers used are formed by reacting polyether polyols and aromatic isocyanates having two or more NCO functionalities.

Also claimed are additives for NCO-containing adhesive formulations for the bonding of lignocellulosic materials comprising modified siloxanes, characterized in that the modifications essentially contain no isocyanate-reactive groups.

A surprising observation was that the addition of silicone surfactants to polyurethane-based adhesive formulations results in the formation of a more stable adhesive join when bonding wood.

The NCO-containing adhesive formulations for the bonding of lignocellulosic materials in each case have an NCO content of 1-25% by weight, preferably an NCO content of 1-20% by weight, more preferably an NCO content of 10-20% by weight, which was measured according to DIN EN ISO 11909 (2007).

The principal component of the NCO-containing adhesive formulations is an isocyanate prepolymer consisting of at least one diisocyanate, for example one or more isomers of methylene diphenyl diisocyanate, toluene diisocyanate, hexamethylene diisocyanate, isophorone diisocyanate, hydrogenated methylene diphenyl diisocyanate and/or a higher isocyanate, for example polymeric methylene diphenyl diisocyanate or trimers, oligomers or homopolymers of the aforementioned diisocyanates and/or mixtures thereof comprising two or more of said isocyanates and at least one isocyanate-reactive substance used in a substoichiometric amount, usually an alcohol compound and/or amine compound, often in the form of polymers, i.e. polyols composed of different monomers. Formulations and also production processes and in some cases subsequent mixtures of individual separately produced prepolymers are known to those skilled in the art, are well described, such as in WO 02/48232 or U.S. Pat. No. 6,133,398 for example, and largely form the basis of polyurethane-based adhesive chemistry.

The modified siloxanes of the invention are selected from the group of derivatives of poly- or oligodimethylsiloxanes, preferably polyether siloxanes, and in particular satisfy the general formula (I)

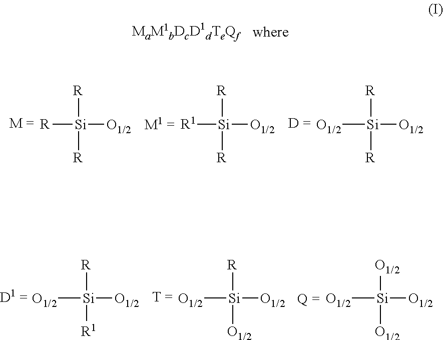

a=0-20, preferably 0-10, in particular 0-2,
b=0-20, preferably 0-10, in particular 0-2,
c=3-200, preferably 4-150, in particular 5-100,
d=0-40, preferably 1-30, in particular 1-20,
e=0-20, preferably 0-10, in particular 0,
f=0-20, preferably 0-10, in particular 0,
where a+b≥2 and also a+b+c+d+e+f≥8 and ≤320, b+d≥1,
R=independently of one another identical or different alkyl radicals having 1-16 carbon atoms or aryl radicals having 6-16 carbon atoms,
or is —O—R²,
where alkyl is preferably methyl, ethyl, octyl or dodecyl, in particular methyl, and aryl is preferably phenyl,
R¹=independently of one another identical or different polyether moieties, preferably identical or different polyether moieties of the general formula (II),

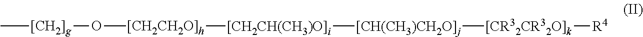

R²=independently of one another identical or different alkyl radicals having 1-16 carbon atoms or aryl radicals having 6-16 carbon atoms,
R³=identical or different alkyl radicals having 1 to 18 carbon atoms that optionally have ether functions, or aryl radicals having 6-18 carbon atoms that optionally have ether functions, or H, preferably H, methyl, ethyl and phenyl,
R⁴=identical or different radicals from the group: R²H, —C(O)R², preferably methyl, butyl or —C(O)Me, where
g=0-18, preferably 0-10, particularly preferably 0 and 3,
h=0-100, preferably 0-80, particularly preferably 0-50,
i=0-100, preferably 0-80, particularly preferably 0-50,
j=0-100, preferably 0-80, particularly preferably 0-50,
k=0-80, preferably 0-40, particularly preferably 0,
with the proviso that h+i+j+k≥3.

In the structural formulas shown for the described polymers, i.e. molecules having more than 3 identical repeat units in their structure, the indices indicate the amounts of the individual repeat units in the theoretical molecule as a number average across the polymer distribution. In the individual molecules actually present, the specified repeat units may be present within the polymer distribution in blocks, in random order, or in another order.

The additives in the NCO-containing adhesive formulations of the invention have
1.) essentially no free alcohol functions or other NCO-reactive functional groups and therefore essentially do not react with the NCO functions of the adhesive formulation under the conditions of storage and use,
2.) in addition, because of the polyether chains, adequate miscibility with the adhesive formulation,
3.) a positive effect on adhesive formulations for the bonding of lignocellulosic materials in respect of the strength of the adhesive join.

For the purposes of the present invention, the additives then have no alcohol functions or other NCO-reactive functional groups, when these have not been specifically incorporated into the molecular structure of the modified siloxanes and are not present in the additive via formulation constituents, for example as solvent or co-emulsifier, in appreciable amounts of >10%, preferably >5%, more preferably >3%. On the other hand, constituents present in minor amounts—for example amines for adjusting the pH of the additive before, during or after production, antioxidants or other constituents of individual auxiliaries needed for the production of the additives—may have alcohol functions or other NCO-reactive functional groups. In practice, it likewise cannot be avoided—for example as a consequence of ageing processes, oxidation, ingress of water and hydrolysis, incomplete reaction, for example of the end-capping reaction in the production process of a polyether used as a raw material, or similar—that the employed raw materials or the additive itself have low levels of NCO-reactive functional groups, especially alcohol functions or water in the additive, or that these are detectable in the additive or detectable in increasing concentration during storage of the additive. These are nonetheless additives that essentially have no alcohol functions or other NCO-reactive functional groups.

From a practical viewpoint, additives are more particularly free of alcohol functions or other NCO-reactive functional groups for the purposes of the present invention when measurement of the OH value according to DIN EN ISO 4629-2 (2016) gives a result of less than 20 mg KOH/g, preferably less than 15 mg KOH/g and more preferably less than 5 mg KOH/g.

In addition to prepolymers and additives, the NCO-containing adhesive formulations comprise further additives and/or auxiliaries. Examples include crosslinkers, fillers, catalysts, defoamers, stabilizers, acids, antioxidants, UV stabilizers, biocides and other ageing stabilizers, viscosity modifiers, plasticizers, dyes, solvents, dispersants, adhesion promoters, flame retardants, hydrolysis stabilizers, desiccants, activators and further auxiliaries and mixtures thereof.

Crosslinkers are preferably selected from the group of oligomers or homopolymers of hexamethylene diisocyanate, one or more mixed isomers of methylene diphenyl diisocyanate, pentamethylene diisocyanate and isophorone diisocyanate and mixtures thereof.

Suitable fillers are metal oxides, for example titanium dioxide, aluminium oxide, zinc oxide, fumed silicon dioxide, surface-treated silicas, sheet silicates such as kaolin, mica, bentonite, or talc and also carbon black. Also suitable are biobased fillers such as cornflour, wheat flour and groundnut shells. Further preferably, fillers are selected from the group of CaCO₃, reinforcing fibres, organic polymers, preferably lignin or cellulose, and mixtures thereof.

Suitable catalysts include tin (II) salts of carboxylic acids, alkyltin (IV) carboxylates, tertiary amines, amino alcohols, alkali metal hydroxides and alkali metal alkoxides. Preferred catalysts of the NCO-containing adhesive formulations of the invention are selected from the group of Polycat® DMDEE (dimorpholinodiethyl ether) Polycat® 557 (Evonik, Germany), dialkyltin (IV) dicarboxylates, dialkyltin (IV) thiols, dialkyltin (IV) thioglycolates and mixtures thereof. It is additionally possible to use a large number of further catalysts, for example those mentioned in EP 1425328.

Examples of suitable plasticizers, solvents and thinners are esters, for example castor oil esters, diesters of phthalic acid, aliphatic diacids, for example adipic acid, or triacids, for example citric acid.

Suitable desiccants for preventing premature curing in the event of moisture ingress during storage and preparation are for example molecular sieve powder, silanes, diethyl malonate and alkyl phenol acrylates.

Hydrolysis stabilizers are substances that are intended to reduce the hydrolysis of the fully cured adhesive join.

Suitable antioxidants and UV stabilizers are for example phenol derivatives, thioesters, phosphates or sterically inhibited amines marketed for this purpose.

Suitable adhesion promoters are di- or trialkoxysilanes.

Suitable flame retardants include bromoalkyl or chloroalkyl phosphate esters, melamine, aluminium oxide hydrate, red phosphorus, ammonium polyphosphate and antimony trioxide.

Suitable defoamers, hydrolysis stabilizers, antioxidants and viscosity modifiers are known to those skilled in the art.

There are various NCO-containing adhesive systems that comprise NCO-containing adhesive formulations. In addition to the abovementioned adhesive formulations, NCO-containing adhesive systems may also include primers. These are used to treat the wood materials to be bonded before applying the adhesive composition, thereby achieving an improvement in adhesive strength, particularly in wet adhesive strength.

Surprisingly, it was found that the use of the additives in NCO-containing adhesive formulations does not require a primer in order to obtain good results in the tensile shear strength test according to DIN EN 302-1 (2017). This makes it possible to avoid a processing step when bonding wood materials, which brings savings in production time and in raw materials needed. In some cases, the additional use of primers is appropriate.

The cured NCO-containing adhesive formulations and cured NCO-containing adhesive systems obtained by polymerization of one of the NCO-containing adhesive formulations of the invention or of one of the NCO-containing adhesive systems of the invention are additionally claimed.

There are various methods for bonding with NCO-containing adhesive formulations.

A method for bonding with NCO-containing adhesive formulations of the invention is claimed that comprises the following method steps:
a) providing at least two identical or different lignocellulosic materials, preferably from wood, more preferably from beech,
b) applying the NCO-containing adhesive formulations to at least one lignocellulosic material,
c) bringing the at least two lignocellulosic materials together,
d) compressing the at least two lignocellulosic materials,
e) optionally post-curing the bonded lignocellulosic materials through storage.

The adhesive may in method step b) be used in amounts of 90-350 g/m², preferably 120-250 g/m², more preferably 140-200 g/m².

Method steps c) and d) may optionally be carried out at elevated temperature and usually at elevated pressure, in order to achieve a fast-curing and firm adhesive join.

For method step c), a pressure of 0.4-2 N/mm², preferably 0.6-1.4 N/mm², may be employed for surface bonding and narrow-side bonding and a pressure of 5-15 N/mm², preferably 7.5-10 N/mm², for finger jointing.

For method step c), a temperature of 0-210° C., preferably 15-40° C., may be employed, for example by means of a heated ambient atmosphere or temperature-controlled presses.

The use of the NCO-containing adhesive formulations of the invention for the bonding of lignocellulosic materials is additionally claimed.

More particularly, the use of the NCO-containing adhesive formulations of the invention for the bonding of softwoods, grasses and hardwoods is claimed.

Particular preference is given here to the bonding of bamboo, miscanthus, cereal straw and hemp shives.

Very particular preference is given to the bonding of beech woods, birch woods, oak woods, eucalyptus, Douglas fir, larch and acetylated wood.

The use of the NCO-containing adhesive formulations of the invention for the bonding of sawn timber, fibres, chips, boards, wood splints, veneers and shavings is also claimed.

The bonded lignocellulosic materials obtained are products that find use in various product groups. For example, they are used in parquet, cross-laminated timber, glue-laminated timber, laminated veneer lumber, solid wood panels, veneer plywood, I-joists, TJI joists and scrimber products.

There is a broad field of application for the use of NCO-containing adhesive formulations. Bonded lignocellulosic materials are used in various application markets. For example, in furniture construction, structural glued laminated timber construction, vehicles and facades.

The NCO-containing adhesive formulations have been found to be suitable also for bonding lignocellulosic materials with other materials, for example metal and plastics, in particular foam materials, ceramics and glass.

### EXAMPLES

### Conditions for the Production of the Test Specimens:

The bonded lignocellulosic materials were produced in accordance with the standard DIN EN 302-1 (2017). Unsteamed beech wood boards were used, which had a DIN-compliant bulk density, wood moisture content, length, thickness and width.

### Preparation of the Test Specimens:

The beech wood board test specimens were supplied in a climatic chamber at a temperature of 18-22° C. and a relative humidity of 60-70% for at least one week.

For the production of the up to 5 wood test specimens, two beech wood boards were bonded. For the reference, an amount of adhesive of 200 g/m² of the 1K polyurethane adhesive Loctite® HB S309 Purbond from Henkel AG & Co. KGaA was used. For the testing of the additive, an adhesive formulation of 1% polyether siloxane and 99% Loctite® HB S309 Purbond from Henkel AG & Co. KGaA was used in an amount of 200 g/m² of adhesive formulation.

After applying the NCO-containing adhesive formulation of the invention, the wood test specimens were laid on top of one another and pressed together lightly. For the reference, an adhesive formulation without polyether siloxane additive was used.

The test specimens were then compressed in a hydraulic press at a press pressure of 1.2-1.3 N/mm² for 75 minutes at room temperature of 20-30° C., after which the bonded materials were stored for 7-14 days under normal climatic conditions. The test specimens were cut to size using a CNC router, by making two offset cuts at right angles to the wood fibre in accordance with the standard. In addition, the two outer sections parallel to the fibre direction were cut away at a distance of 7.5 mm from the edges and discarded.

### Aftertreatments A1 and A4:

For examples 2 and 4, the wood test specimens were treated in accordance with the aftertreatment A4 described in DIN EN 302-1 (2017).

For samples in accordance with A4, the samples were first boiled in water for 6 hours and then, in a departure from the standard, immersed in cold water overnight instead of just for two hours, and measured wet in the longitudinal shear test. For aftertreatment in accordance with A1, no further steps were carried out after storage in normal climatic conditions for 1-2 weeks.

### Procedure for the Longitudinal Shear Test:

The test specimens were clamped parallel to the direction of stress in the clamping jaws of the tensile testing machine at a distance of 90 mm and tested with the increase in load of 2.0 [±0.5] kN/min specified in standard DIN 302-1 (2017). The test was judged to have ended when the test specimen fractured. Test specimens that were significantly twisted and could not be clamped in the jaws without generating a tension in the adhesive join at right angles to the fibre direction were not included in the calculation of the mean value. Such test specimens often already delaminate before the longitudinal shear test while being clamped in the clamping jaws.

### Determination of Wood Tear-Out:

After carrying out the longitudinal tensile shear test, the wood tear-out is determined by analysing the two test specimen fragments using a Keyence VR-5000 optical 3D profilometer. In this test, raised areas or depressions respectively higher or deeper than 0.1 mm are considered to be wood tear-out. The wood tear-out shown in the table is the mean value of all wood tear-outs.

### Preparation of the Additives:

Additives A and B were synthesized by the hydrosilylation reactions of monoallyl monoalkyl polyethers with hydrosiloxanes known to those skilled in the art (see for example DE 10 2014 218 635 A1, EP 0 493 836 A1, EP 1 520 870 B1). Additive A satisfies formula I where a=0, b=2, c=35, d=3, e=0, f=0, R=methyl and R¹ is a polyether moiety where g=3, h=15, i+j=4, k=0 and R⁴=methyl, and additive B where a=0, b=2, c=35, d=3, e=0, f=0, R=methyl and R¹ is a polyether moiety where g=3, h=14, i=0, j=0, k=0 and R⁴=methyl. For both additives, the OH value determined in accordance with DIN EN ISO 4629-2 (2016) was 3 mg KOH/g.

| | | | Mean lon- | Mean | Number |
|---|---|---|---|---|---|
| | | Aftertreatment | gitudinal | wood | of test |
| | | in accordance | tensile | tear- | specimens |
| | | with DIN EN | strength | out | for mean |
| | | 302-1 (2017) | [N/mm2] | [%] | value |
| Reference | Without | A1 | 12.2 | 41 | 18 |
| 1 | additives | | | | |
| Reference | Without | A4 | 4.8 | 62 | 14 |
| 2 | additives | | | | |
| Example 1 | Additive A | A1 | 11.9 | 89 | 10 |
| Example 2 | Additive A | A4 | 6.3 | 49 | 10 |
| Example 3 | Additive B | A1 | 12.8 | 53 | 10 |
| Example 4 | Additive B | A4 | 7.1 | 71 | 5 |

Examples 1 and 3 show that the longitudinal shear strengths of the test specimens with the NCO-containing adhesive formulations of the invention in the dry state show no substantial change compared to reference 1 without additive. When the bonded test specimens undergo aftertreatment in accordance with DIN EN 302-1 (2017) A4, it is found that the longitudinal shear strengths of the test specimens with the NCO-containing adhesive formulations comprising additives (examples 2 and 4) were significantly improved compared to reference 2.

A further criterion is wood tear-out. The wood tear-out is regarded as a further measure of the strength of the adhesive join. High wood tear-out percentages, ideally of 100%, are considered particularly advantageous. The experiments show that the NCO-containing adhesive formulations of the invention improve wood tear-out under the conditions according to DIN EN 302-1 (2017) A1.

1. An NCO-containing adhesive formulation for the bonding of lignocellulosic materials comprising modified siloxanes, the NCO-containing adhesive formulation comprising:
at least one additive,
wherein modifications essentially contain no isocyanate-reactive groups.

2. The NCO-containing adhesive formulation according to claim 1 based on isocyanate prepolymers for the bonding of lignocellulosic materials from the group of modified siloxanes, wherein the modifications essentially contain no isocyanate-reactive groups and wherein the isocyanate prepolymers used are formed by reacting polyether polyols and aromatic isocyanates having two or more NCO functionalities.

3. The NCO-containing adhesive formulation according to claim 2, wherein the NCO-containing adhesive formulation has an NCO content of 1-25% by weight.

4. The NCO-containing adhesive formulation according to claim 2, wherein the modified siloxanes are selected from polyether siloxanes

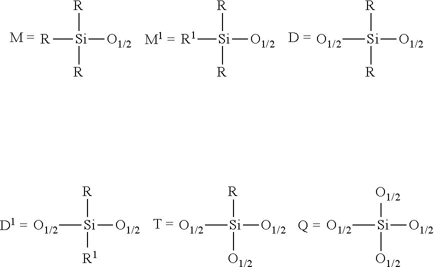

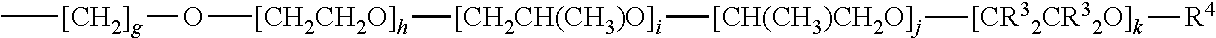

5. The NCO-containing adhesive formulation according to claim 2, comprising crosslinkers, fillers, catalysts, stabilizers, defoamers, antioxidants, viscosity modifiers, activators, further auxiliaries and mixtures thereof.

6. The NCO-containing adhesive formulation according to claim 5, wherein the crosslinkers are selected from the group consisting of oligomers and homopolymers of hexamethylene diisocyanate, pentamethylene diisocyanate and isophorone diisocyanate, and mixtures thereof.

7. The NCO-containing adhesive formulation according to claim 5, wherein the fillers are selected from the group consisting of CaCO₃, reinforcing fibres, kaolin, organic polymers, and mixtures thereof.

8. The NCO-containing adhesive formulation according to claim 5, wherein suitable catalysts are selected from the group consisting of tin salts of carboxylic acids, tertiary amines, amino alcohols, alkali metal hydroxides and alkali metal alkoxides, and mixtures thereof.

9. An NCO-containing adhesive system, comprising:
the NCO-containing adhesive formulation according to claim 1, which optionally comprises a primer.

10. A cured NCO-containing adhesive formulation obtained by polymerization of the NCO-containing adhesive formulation according to claim 2.

11. A method for bonding with the NCO-containing adhesive formulation according to claim 1, the method comprising:
a) providing at least two identical or different lignocellulosic materials,
b) optionally applying a primer,
c) applying the NCO-containing adhesive formulation to at least one lignocellulosic material,
d) bringing the at least two lignocellulosic materials together,
e) compressing the lignocellulosic materials,
f) optionally post-curing the bonded lignocellulosic materials through storage.

12. A method, comprising:
bonding of lignocellulosic materials with the NCO-containing adhesive formulation according to claim 1.

13. The method according to claim 12, wherein the lignocellulosic materials are selected from the group consisting of softwoods, grasses, hardwoods, beech woods, birch woods, oak woods, eucalyptus, Douglas fir, larch, acetylated wood, bamboo, miscanthus, cereal straw and hemp shives.

14. The method according to claim 12, wherein the lignocellulosic materials are selected from the group consisting of sawn timber, fibres, chips, boards, wood splints, veneers, parquet, cross-laminated timber, glue-laminated timber, laminated veneer lumber, solid wood panels, veneer plywood, I-joists, TJI joists, scrimber products and shavings.

15. The method according to claim 12, wherein the NCO-containing adhesive formulation is used in furniture construction, structural glued laminated timber construction, vehicles and facades.
